(19) United States
(12) Patent Application Publication
(10) Pub. No.: US 2026/0202581 A1
(43) Pub. Date: Jul. 16, 2026

(54) AN OPTICAL ELEMENT, AN OPTICAL UNIT AND OPTICAL DEVICES

(71) Applicant: Agency for Science, Technology and Research, Singapore (SG)

(72) Inventors: Shampy Mansha, Singapore (SG); Ramon Jose Paniagua-Dominguez, Singapore (SG); Arseniy Kuznetsov, Singapore (SG)

(21) Appl. No.: 19/138,144

(22) PCT Filed: Nov. 6, 2023
(86) PCT No.: PCT/SG2023/050733

§ 371 Date: Jun. 12, 2025

(30) Foreign Application Priority Data
Dec. 14, 2022 (SG) 10202260441W

(51) Int. Cl. G02B 1/00; G01J 3/28; G02B 1/02

(52) U.S. Cl. CPC G02B 1/005; G02B 1/02; G01J 2003/2806; G02B 2207/101

(57) ABSTRACT

In some aspects, an optical element is provided. The optical element includes a substrate; a Bragg reflector disposed on the substrate; a nanoparticle disposed over the Bragg reflector; and a spacer disposed between the Bragg reflector and the nanoparticle. The nanoparticle is surrounded by dielectric material disposed on the spacer.

### TECHNICAL FIELD

The present disclosure generally relates to an optical element, an optical unit and optical devices.

### BACKGROUND

Spectroscopy is the branch of science that deals with the study of light matter interaction and helps to obtain the intensity of electromagnetic waves as a function of their wavelength or frequency, in order to characterize, analyse or image the properties of the matter. It is a widely popular technique and has immense applications in the field of chemical characterization, bio sensing, tissue imaging, agriculture or astronomy, among various other applications. Traditionally, spectrometers consist of bulky optical components, like diffraction gratings, lenses and/or mirrors and comprise large optical path lengths between them, making their miniaturization difficult and rendering them not suitable for handheld or portable devices.

Therefore, there exists a need to miniaturize these components, and make the spectrometers compact and lightweight for frequent consumer or industry use in day-to-day detection.

### SUMMARY

According to a first aspect of the present disclosure, an optical element is provided. The optical element may include a substrate; a Bragg reflector disposed on the substrate; a nanoparticle disposed over the Bragg reflector; and a spacer disposed between the Bragg reflector and the nanoparticle, wherein the nanoparticle is surrounded by dielectric material disposed on the spacer.

According to a second aspect of the present disclosure, an optical unit is provided. The optical unit may include an array of optical elements, wherein each optical element is configured as described herein, wherein the optical elements are periodically arranged in the X- and Y-directions, the X- and Y-directions being perpendicular to a transmission direction of the optical elements, and nanoparticles of the array of optical elements form a metasurface configured to resonate with incident light on the optical unit; or the optical unit comprising: a substrate; a Bragg reflector disposed on the substrate; a spacer disposed on the Bragg reflector; a metasurface disposed on the spacer and configured to resonate with incident light on the optical unit, the metasurface comprising an array of nanoparticles surrounded by dielectric material.

According to a third aspect of the present disclosure, an optical device is provided. The optical device may include an array of optical units, wherein each optical unit is configured as described herein, wherein nanoparticles of the array of optical units are of the same height.

According to a fourth aspect of the present disclosure, an optical device is provided. The optical device may include a substrate; a Bragg reflector disposed on the substrate; a spacer disposed on the Bragg reflector; a metasurface disposed on the spacer and configured to resonate with incident light on the optical device, the metasurface comprising a plurality of arrays of nanoparticles surrounded by dielectric material.

### BRIEF DESCRIPTION OF THE DRAWINGS

FIG. 1 is a block diagram depicting an optical element according to various embodiments of the present disclosure.

FIG. 2A and FIG. 2B are block diagrams depicting optical elements according to various embodiments of the present disclosure.

FIG. 3 shows a simulated colormap (grayscale) depicting reflectance from a nanoparticle for x-polarized light incident from the top of the nanoparticle according to various embodiments of the present disclosure.

FIG. 4A and FIG. 4B show simulated reflectance plots from a nanoparticle with a radius of 250 nm and a radius of 320 nm, respectively, according to various embodiments of the present disclosure.

FIG. 5A and FIG. 5B show multipole decomposition spectrums of scattering cross-section by a nanoparticle with a radius of 260 nm and 320 nm, respectively, according to various embodiments of the present disclosure.

FIG. 6A shows simulated transmission spectra colormap (grayscale) of the optical element of FIG. 1 with the height of the spacer varying from 0 nm to 2400 nm; and FIG. 6B shows an enlarged section of FIG. 6A where m is 3 and the wavelength is around 1380 nm.

FIGS. 7A to 7C show the transmittance spectra for the particular cases h=1640 nm, 1680 nm, and 1720 nm, respectively, in accordance with the circled points of FIG. 6B.

FIG. 8A shows simulated transmission spectra colormap (grayscale) of the optical element of FIG. 1 with the height of the spacer varying from 0 nm to 2400 nm; and FIGS. 8B and 8C show enlarged sections of FIG. 8A where m is 3 and the wavelength is around 1429.5 nm and 1560.5 nm, respectively.

FIGS. 9A to 9F show the transmittance spectra for the different heights of a spacer, h=1970 nm, 1990 nm, 2000 nm, 2010 nm, 2020 nm and 2040 nm, respectively.

FIG. 10 shows simulated transmission plots as a function of wavelengths for the optical element of FIG. 1.

FIG. 11 is a block diagram depicting an optical unit according to various embodiments of the present disclosure.

FIG. 12 is a block diagram depicting an optical device according to various embodiments of the present disclosure.

FIG. 13 is a block diagram depicting an optical device according to various embodiments of the present disclosure.

### DETAILED DESCRIPTION

Embodiments described below in the context of a device, apparatus, or system are analogously valid for the respective methods, and vice versa. Furthermore, it will be understood that the embodiments described below may be combined, for example, a part of one embodiment may be combined with a part of another embodiment, and a part of one implementation may be combined with a part of another implementation.

It should be understood that the singular terms “a”, “an”, and “the” include plural references unless context clearly indicates otherwise. Similarly, the word “or” is intended to include “and” unless the context clearly indicates otherwise.

It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more steps or elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Approximating language, as used herein throughout the specification and claims, may be applied to modify any quantitative representation that could permissibly vary without resulting in a change in the basic function to which it is related. Accordingly, a value modified by a term or terms, such as “about,” “substantially”, is not limited to the precise value specified but within tolerances that are acceptable for operation of the embodiment for an application for which it is intended. In some instances, the approximating language may correspond to the precision of an instrument for measuring the value.

Several approaches may be utilized towards the miniaturization of the spectrometers, including dispersion optics, narrowband filters, Fourier transform and reconstructive optics. Among the spectrometer miniaturization approaches, the use of narrowband filters is particularly interesting as it leads to significant reduction in the optical path length. Common filters proposed, range from Fabry Perot cavities, to micro-electromechanical system (MEMS), metasurface arrays, colour dyes. These techniques have the advantage that the pixels can be very small—of the size of several micrometres—and have the potential to be directly integrated on the photodetectors, removing the need for bulky optical elements.

The Fabry Perot (FP) cavity approach, which is simple to fabricate and imparts very narrow resonances may have several limitations, the main one being that, once a cavity height is determined, it gives resonance(s) at fixed wavelengths. In order to spectrally tune these resonances in a FP cavity, either one needs to change the length/thickness of the cavity or change the optical path of light. The first approach may be done statically, by fabricating different filters with different cavity lengths (which turns out to be a very complex fabrication process if several filters are desired on a single substrate) or dynamically, by using complex MEMS technology (which affects the robustness of the device and limits the operation wavelength). The second approach, in which the optical path is modified by changing the refractive index of the medium filling the cavity, may be achieved using acousto-optical modulators or liquid crystal (but this comes at the cost of power consumption, device complexity and, again, a limited tuning range). 1D photonic crystals have also emerged as one of the approaches to achieve narrow-band filters. They comprise distributed Bragg reflectors (DBRs), which consist of dielectric layers of alternating high and low refractive index materials, and a defect layer that is introduced between these dielectric layers and that leads to the emergence of a so-called “defect mode”, which appears as sharp resonance(s) in the spectrum.

The abovementioned devices may be several micrometres thick owing to the large number of dielectric layers involved in their design and; the spectral tuning of the defect mode presents the same problem as in FP cavity-based ones, namely that to obtain a different operating wavelength a different cavity thicknesses may be required. Using metasurfaces for narrow band filters has also gained momentum in recent years. Metasurfaces are collections of subwavelength nanostructures, which can modulate the properties of light. Dielectric metasurfaces, in particular, have emerged as a popular choice owing to their lower losses compared to metallic (plasmonic) ones. In the context of the Fabry Perot tunable planar filters, metasurfaces may be embedded inside a FP cavity and, while keeping the height of the cavity fixed, the narrowband transmitted light enabled by the system resonances could be tuned by just changing the geometrical parameters (width) of the metasurface. The FP cavity may be formed by using two separate distributed Bragg reflectors (on top and bottom), the resonances of which were then tuned by introducing a non-resonant metasurface, which acts as a phase retarder. This approach may involve a complex fabrication (2 DBRs and a metasurface embedded between them, for which planarization and precise thicknesses of the layer above the metasurface becomes critical). Another, simpler, possibility to obtain planar transmissive filters using metasurfaces is employing narrow collective resonances supported by this type of system, known as quasi-bound states in the continuum (qBIC). This approach allows for single layer fabrication, simplifying the fabrication and reducing the device thickness. However, one key limitation is that these devices are intrinsically polarization dependent. Another limitation is that the finesse and amplitude of their resonance linewidth is very sensitive to fabrication imperfections and to the total metasurface size (hindering the robustness of the device performance and making lateral miniaturization challenging).

Various aspects of what is described here seek to provide an optical device, for example, a planar transmissive filter, which is based on a metasurface-DBR microcavity. The present optical device may include a Bragg reflector (e.g. partially but highly reflective (e.g. >90%) distributed Bragg reflector, Bragg mirror); a spacer disposed on the Bragg reflector; and a (dielectric, non-metallic) metasurface disposed on the spacer and configured to resonate with incident light on the optical device. The metasurface may include a plurality of arrays/collection of optically resonant nanoparticles surrounded by dielectric material and dimensions of the nanoparticles may be smaller than the wavelength of the incident light. In other words, the spacer may be disposed between the Bragg reflector and the metasurface, a height of the spacer being a distance between the Bragg reflector and the metasurface. The present optical device may provide a narrowband transmission of the incident light which results from the strong coupling between two optical (Mie) resonances excited in (the nanoparticles of) the metasurface (with electric-dipoles and magnetic-dipoles, respectively, at a same wavelength) and the Fabry-Perot like mode from the cavity (formed by the spacer between the Bragg reflector and the metasurface). Accordingly, a single Fabry-Perot cavity may be provided for the present optical device; that is, no external Fabry-Perot cavity is needed.

In various aspects, the dielectric metasurface may include transparent cylindrical nanoparticles made of a transparent and high refractive index material (with n>2 and k<0.1) in the wavelength range of interest, where n and k are the real and imaginary parts of the complex index of refraction, respectively). The metasurface may be spaced apart from the Bragg reflector by a transparent low refractive index dielectric spacer (with n<2 and k<0.1 in the wavelength range of interest). The Bragg reflector may include a multilayer stack of optically thin films of alternating high- and low-index transparent dielectric materials. The metasurface and the Bragg reflector may be designed in a manner that they independently (e.g. individually) have high reflectance (e.g. R>90%), but when combined together give rise to spectrally narrow (e.g. defined as having a Q-factor on the orders of 10³) transmission band with high associated transmittance (e.g. T>80%) and with a wide rejection bandwidth around it (e.g. ΔΛ>350 nm, and defined as having T<10%).

In some aspects, the present optical device may operate at the infrared wavelengths (e.g. 1200 nm-1800 nm range and, specifically, 1400 nm). That is, the wavelengths of the transmission band may be at the infrared wavelengths (e.g. 1200 nm-1800 nm range and, specifically, 1400 nm). The transmission band of the present optical device may be spectrally tuned by changing the geometrical parameters of the metasurface (e.g. the radius r of the cylindrical nanoparticles, the shape of the nanoparticles, or the lattice periodicity), while keeping the metasurface thickness t and the spacing distance h to the Bragg reflector unchanged (and, accordingly, keeping the overall height of the optical device unchanged). Advantageously, the present optical device may be directly integrated as a spectrally narrow transmissive filter over different pixelated photodetectors, to thus create miniaturized spectrometers, which otherwise are bulky due to their optical components and the optical path between them. Stated differently, the present optical device may allow the realization of different filters with different operational wavelengths on the same substrate without requiring complex (multi-height or greyscale) nanofabrication techniques.

In some aspects, the metasurface may be designed such that the nanoparticles of the metasurface support two optical (Mie) resonances at the same wavelength, leading to a high reflectance (R>90%) at that wavelength. This may be obtained by tuning the geometrical parameters and/or the periodicity of the periodic array of nanoparticles.

In some aspects, the height of the spacer, i.e. the distance between the metasurface and the Bragg reflector may be designed so as to form the cavity modes resulting from the partial reflection of light from each of these elements, i.e. of a similar nature of Fabry-Perot modes. These cavity modes may then couple with the Mie resonances excited in the metasurface, resulting into spectrally narrow transmission of light with transmissivity T>80% embedded in a spectrally broad band of reflected light (rejection band), with large bandwidths (exceeding 350 nm for T<10%). When the metasurface supports two Mie resonances with distinct electric and magnetic character and these are spectrally close (i.e. with partial spectral overlap), the present optical device with the Bragg reflector at the optimized distance from the metasurface may lead to a single peak in the transmission spectrum. In other aspects, if the two Mie resonances are well separated spectrally, then multiple transmission bands may appear, which in turn narrows the bandwidth of the rejection band.

According to various aspects, the proposed optical device may provide an advantageous design. The strong coupling of the optical Mie resonances (from metasurface) and Fabry-Perot modes (from metasurface-DBR cavity) may result into a highly transmissive and spectrally sharp resonance, with high Q-factor (and generally an asymmetric line shape, corresponding to a Fano-like resonance) and wide rejection bandwidth. The narrow transmission band may be spectrally tuned by simply changing the metasurface geometrical parameters, while keeping the metasurface thickness, as well as the distance between the Bragg reflector and the metasurface unchanged.

The following examples pertain to various aspects of the present disclosure.

Example 1 is an optical element, including: a substrate; a Bragg reflector disposed on the substrate; a nanoparticle disposed over the Bragg reflector; and a spacer disposed between the Bragg reflector and the nanoparticle, wherein the nanoparticle is surrounded by dielectric material disposed on the spacer.

In Example 2, the subject matter of Example 1 may optionally include that the Bragg reflector comprises a distributed Bragg reflector having a multilayer stack of alternate high- and low-index optically thin films.

In Example 3, the subject matter of Example 2 may optionally include that thicknesses of the high- and low-index optically thin films are in proportion to a target wavelength and inversely proportional to refractive indexes of the high- and low-index optically thin films, and the thicknesses of the high-index optically thin films are less than the thicknesses of the low-index optically thin films.

In Example 4, the subject matter of Example 2 may optionally include that the high-index optically thin films are made of silicon (Si), titanium dioxide (TiO2), silicon nitride (Si3N4), gallium nitride (GaN), and/or gallium phosphide (GaP), and the low-index optically thin films are made of silicon dioxide (SiO2), calcium fluoride (CaF2), and/or aluminum oxide (Al2O3).

In Example 5, the subject matter of Example 1 may optionally include that the spacer is made of low-index dielectric material including at least one of silicon dioxide (SiO2), calcium fluoride (CaF2), or aluminum oxide (Al2O3).

In Example 6, the subject matter of Example 1 may optionally include that the nanoparticle is made of high refractive index dielectric and semiconductor materials including at least one of amorphous silicon (□-Si), titanium dioxide (TiO2), silicon nitride (Si3N4), gallium nitride (GaN), gallium phosphide (GaP), or diamond.

In Example 7, the subject matter of Example 1 may optionally include that the substrate is made of low-index dielectric material including at least one of silicon dioxide (SiO2), calcium fluoride (CaF2), or aluminum oxide (Al2O3).

In Example 8, the subject matter of Example 1 may optionally include that the nanoparticle is surrounded by low-index dielectric material including at least one of silicon dioxide (SiO2), calcium fluoride (CaF2), or aluminum oxide (Al2O3).

In Example 9, the subject matter of Example 1 may optionally include that the spacer has a height enabling Fabry-Perot like resonances.

In Example 10, the subject matter of Example 1 may optionally include that the nanoparticle is of a cylindrical shape, a cubical shape, a cuboid shape, or a cross shape.

In Example 11, the subject matter of Example 1 may optionally include that the nanoparticle has a radius enabling overlapped electric pole and magnetic pole resonances.

Example 12 is an optical unit, the optical unit comprising: an array of optical elements, wherein each optical element is configured as recited in Example 1, wherein the optical elements are periodically arranged in the X- and Y-directions, the X- and Y-directions being perpendicular to a transmission direction of the optical elements, and nanoparticles of the array of optical elements form a metasurface configured to resonate with incident light on the optical unit; or the optical unit comprising: a substrate; a Bragg reflector disposed on the substrate; a spacer disposed on the Bragg reflector; a metasurface disposed on the spacer and configured to resonate with incident light on the optical unit, the metasurface comprising an array of nanoparticles surrounded by dielectric material.

In Example 13, the subject matter of Example 12 may optionally include that the nanoparticles of the array of optical elements are of a same height and radius.

In Example 14, the subject matter of Example 12 may optionally include that the metasurface is symmetrical in its plane.

Example 15 is an optical device, comprising: an array of optical units, wherein each optical unit is configured as recited in Example 12, wherein nanoparticles of the array of optical units are of the same height.

In Example 16, the subject matter of Example 15 may optionally include that radii of nanoparticles in one optical unit of the array of optical units are different from radii of nanoparticles in a neighboring unit of the array of optical units.

In Example 17, the subject matter of Example 15 may optionally include that the array of optical units is of a same length and width, respectively.

In Example 18, the subject matter of Example 15 may optionally include that the optical device comprises a transmissive planar filter.

Example 19 is an optical device, comprising: a substrate; a Bragg reflector disposed on the substrate; a spacer disposed on the Bragg reflector; a metasurface disposed on the spacer and configured to resonate with incident light on the optical device, the metasurface comprising a plurality of arrays of nanoparticles surrounded by dielectric material.

In Example 20, the subject matter of Example 19 may optionally include that one array of nanoparticles has a same radius different from a same radius of a neighboring array of nanoparticles.

In the following description, example configurations and systems/devices are first described that may employ the techniques described herein. Example details and methods are then described which may be performed in the example configurations and by the systems/devices as well as in other configurations and by other systems/devices. Consequently, implementation of the example details and methods is not limited to the example configurations and systems/devices, and the example configurations and systems/devices are not limited to the example details and methods.

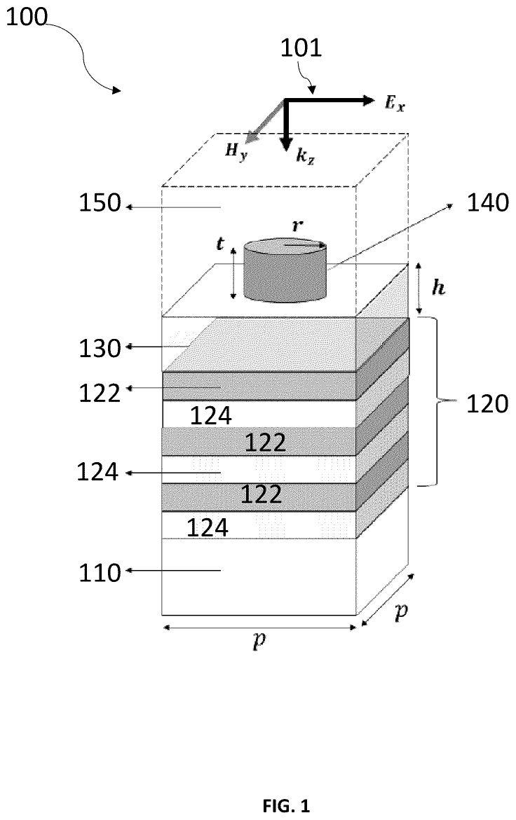

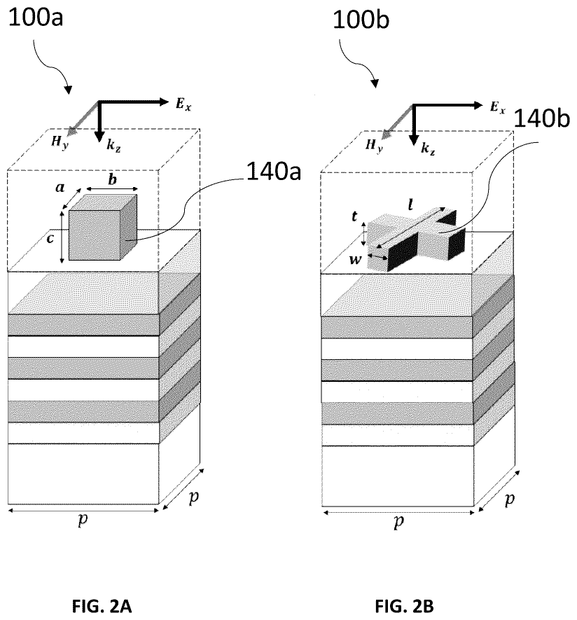

FIG. 1 is a block diagram depicting an optical element 100 according to various embodiments of the present disclosure. FIG. 2A and FIG. 2B are block diagrams depicting optical elements 100a and 100b respectively, according to various embodiments of the present disclosure. FIG. 1 also shows a frame of reference 101 having three orthogonal axes. The frame of reference 101 includes a first axis in a first direction (e.g., the X-direction), a second axis in a second direction (e.g., the Y-direction), and a third axis in a third direction (e.g., the Z-direction). The first, second, and third directions are perpendicular to each other. The frame of reference 101 also shows a propagation direction kz of an incident electromagnetic wave (e.g. a visible light) along the Z-direction, an electric field vector Ex along the X-direction and a magnetic field vector Hy along the Y-direction.

According to various non-limiting embodiments, the optical element 100, 100a, 100b, may include a substrate 110, a Bragg reflector 120 disposed on the substrate 110, a nanoparticle 140, 140a, 140b, disposed over the Bragg reflector 120, and a spacer 130 disposed between the Bragg reflector 120 and the nanoparticle 140, 140a, 140b. The nanoparticle 140, 140a, 140b, may be surrounded by dielectric material 150 disposed on the spacer 130. The optical element 100, 100a, 100b may have XY periodicity of p, p, that is, a same periodicity in the X- and Y-directions (e.g. a square).

According to various non-limiting embodiments, the substrate 110 may be made of low-index dielectric material including silicon dioxide (SiO₂), calcium fluoride (CaF₂), aluminum oxide (Al₂O₃) and the like.

According to various non-limiting embodiments, the nanoparticle 140 may be of a cylindrical shape as shown in FIG. 1, having a radius denoted as r and a height donated as t. In some embodiments, as shown in FIG. 2A and FIG. 2B, the optical element 100a may include the nanoparticle 140a of a cubical/cuboid shape having XYZ dimensions denoted as b, a, c, and the optical element 100b may include the nanoparticle 140b of a cross shape having XYZ dimensions denoted as w, l, t. It should be appreciated that the shape and configuration of the nanoparticle is not limited to the shape and configuration as shown in FIGS. 1, 2A and 2B but include any possible and suitable shape and configuration so as to enable transmission of the incident electromagnetic wave (e.g. light). Features that are described in the context of the optical element 100 may correspondingly be applicable to the same or similar features in the optical element 100a, 100b. Furthermore, additions and/or combinations and/or alternatives as described for a feature in the context of the optical element 100 may correspondingly be applicable to the same or similar feature in the optical element 100a, 100b.

Referring back to FIG. 1, according to various non-limiting embodiments, the nanoparticle 140 may be made of high refractive index dielectric and semiconductor materials including amorphous silicon (□-Si), titanium dioxide (TiO₂), silicon nitride (Si₃N₄), gallium nitride (GaN), gallium phosphide (GaP), diamond and the like. A high refractive index material is generally agreed to have a refractive index of >1.50. For example, the amorphous silicon has a refractive index of 3.4.

According to various non-limiting embodiments, the nanoparticle 140 may be surrounded by low-index dielectric material 150 including silicon dioxide (SiO₂), calcium fluoride (CaF₂), aluminum oxide (Al₂O₃) and the like. The high refractive index material of the nanoparticle 140 may be integrated with the surrounding dielectric material 150 of the contrasting low refractivity to form a transparent component.

Simulations may be performed by using open source software based on the Rigorous Coupled Wave Analysis (RCWA) method and a commercially available software based on the Finite Element Method.

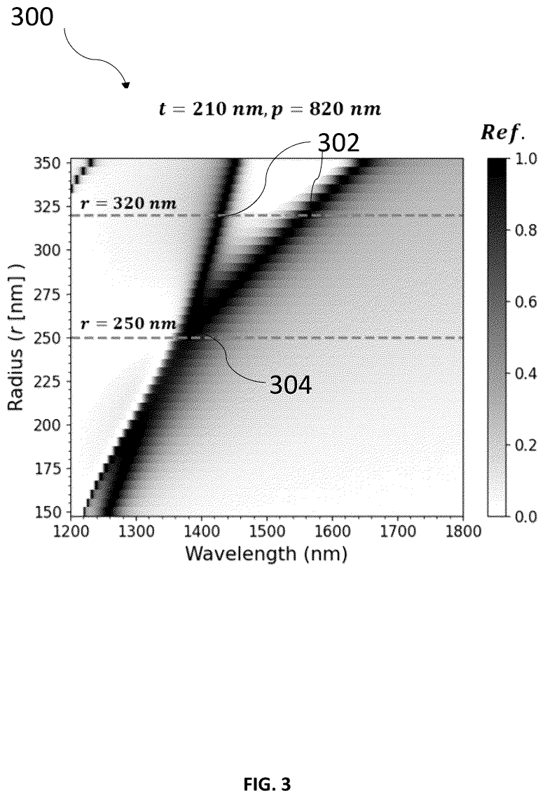

FIG. 3 shows a simulated colormap (grayscale) 300 depicting reflectance from the nanoparticle 140 for x-polarized light incident from the top of the nanoparticle 140. The simulation may be performed by full wave simulation for the nanoparticle 140 only, that is, the other structures including the spacer 130, the Bragg reflector 120 and the substrate are omitted. The radius of the nanoparticle 140 may be varied (e.g. from 150 nm to 350 nm) to obtain the reflectance colormap 300 as a function of wavelengths as shown in FIG. 3, while keeping the height (e.g. t=210 nm) of the nanoparticle 140 and the periodicity in the XY-directions (e.g. p=820 nm) of the nanoparticle 140 unchanged. FIG. 3 shows that high reflectance (~100%, according to the right vertical axis Ref.) resonances can be obtained and spectrally tuned as the radius of the nanoparticle 140 varies (specifically, the radii, r=320 nm and r=250 nm, are denoted by the two dashed lines in FIG. 3). For r=320 nm, two high reflectance resonances 302 are found; for r=250 nm, one high reflectance resonance 304 is found. FIG. 3 shows it changes from one (overlapped) high reflectance resonance to two high reflectance resonances as the radius increases from 275 nm.

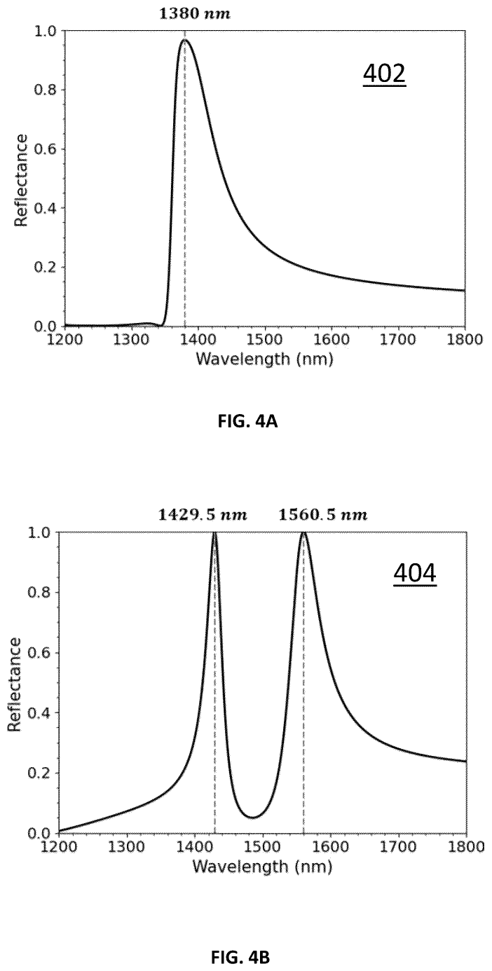

FIG. 4A and FIG. 4B show simulated reflectance graphs 402, 404, from the nanoparticle 140 with a radius of 250 nm and a radius of 320 nm, respectively. The simulation may be performed by full wave simulation for the nanoparticle 140 only, that is, the other structures including the spacer 130, the Bragg reflector 120 and the substrate are omitted. The height (e.g. t=210 nm) of the nanoparticle 140 and the periodicity in XY-directions (e.g. p=820 nm) of the nanoparticle 140 are kept unchanged for FIGS. 4A and 4B. In FIG. 4A, the radius of the nanoparticle 140 is of 250 nm, i.e. r=250 nm. FIG. 4A shows two (partially) spectrally overlapped resonances (which appear as a single peak in reflectance at the wavelength of 1380 nm) which correspond to the dashed line r=250 nm in FIG. 3. In FIG. 4B, the radius of the nanoparticle 140 is of 320 nm, i.e. r=320 nm. FIG. 4B shows two spectrally separated resonances (which appear as two distinct peaks in reflectance with wavelength of 1429.5 nm and 1560.5 nm) which correspond to the dashed line r=320 nm in FIG. 3. Given that the nanoparticle 140 may be symmetric in X-Y plane, the same results may be obtained for the Y-polarized light. In others words, the nanoparticle 140 may be polarization independent.

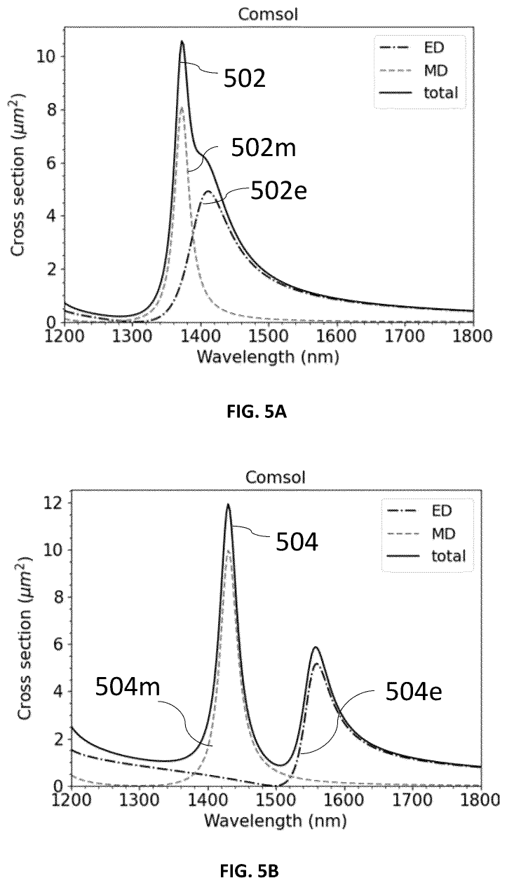

FIG. 5A and FIG. 5B show multipole decomposition spectrums of scattering cross-section by the nanoparticle 140 with the radius of 260 nm and 320 nm, respectively. The simulation may be performed by full wave simulation for the nanoparticle 140 only, that is, the other structures including the spacer 130, the Bragg reflector 120 and the substrate are omitted. The height (e.g. t=210 nm) of the nanoparticle 140 and the XY-periodicity (e.g. p=820 nm) of the nanoparticle 140 are kept unchanged for FIGS. 5A and 5B. FIG. 5A shows that an electric dipole (ED) resonance 502e and a magnetic dipole (MD) resonance 502m are spectrally overlapped and denoted separately by dashed lines. The total scattering cross section 502, obtained as the sum of the cross sections from the ED resonance 502e, the MD resonance 502m, electric quadrupole (EQ) and magnetic quadrupole (MQ) modes. The EQ and MQ modes are not shown in the plot as their value is negligible in the range of interest. The total scattering cross section 502 correlates with the reflectance graph 402 of FIG. 4A. FIG. 5B shows that an ED resonance 504e in the longer wavelength range (e.g. above 1500 nm), a MD resonance 504m in the shorter wavelength range (e.g. below 1520 nm) and the total scattering cross section 504. The ED resonance 504e is separately from the MD resonance 504m and accordingly, two peaks of the total scattering cross section 504 are formed. The total scattering cross section 504 corresponds to the reflectance plot 404 of FIG. 4B. The nanoparticle 140 may be designed so as to support the overlapped ED and MD resonances as described herein.

Referring back to FIG. 1, according to various non-limiting embodiments, the Bragg reflector 120 may include a distributed Bragg reflector having a multilayer stack of alternate high- and low-index optically thin films 122, 124. The high-index optically thin films 122 may be made of silicon (Si), titanium dioxide (TiO₂), silicon nitride (Si₃N₄), gallium nitride (GaN), and/or gallium phosphide (GaP), and low-index optically thin films 124 may be made of silicon dioxide (SiO₂), calcium fluoride (CaF₂), and/or aluminum oxide (Al₂O₃). It should be appreciated that the number of layers of the Bragg reflector 120 is not limited to the six layers as shown in FIG. 1 but include any even numbers of layers according to requirements for the optical element 100 as accordingly determined, for example, as described hereinafter.

According to various non-limiting embodiments, reflectance from the Bragg reflector 120 may be optimized through simulation. The simulation may be performed by full wave simulation using an optical element merely including the surrounding material 150 disposed on the Bragg reflector 120 and Bragg reflector 120 disposed on the substrate 110, that is, the nanoparticle 140 and the spacer 130 are omitted from the simulation. Thicknesses of the high- and low-index optically thin films 122, 124 may be determined by a target wavelength of an incident light and refractive indexes of the high- and low-index optically thin films 122, 124.

In some embodiments, the Bragg reflector 120 may include three pairs of α-Si/SiO₂ dielectric layers 122, 124 (i.e. the optically thin films 122, 124 as shown in FIG. 1). The thickness of the dielectric layers (t_{layer}) of the Bragg reflector 120 may be estimated using the equation:

$${t}_{layer} = \frac{{λ}_{target}}{4 {n}_{layer}} \qquad ( 1 )$$

Where, λ_{target} is the target wavelength and n_{layer} is the refractive index of the dielectric layer (with refractive index 3.4 for α-Si and 1.46 for SiO₂ layers, respectively). A working wavelength in the telecommunications band may be set as the target wavelength, namely of λ_{target}=1500 nm.

According to equation (1), the thickness for α-Si layer is determined as about 110.29 nm and the thickness of SiO₂ layer is determined as about 256.85 nm. Accordingly, the thicknesses of the high-index optically thin films (e.g. α-Si layer) 122 are less than the thicknesses of the low-index optically thin films (e.g. SiO₂ layer) 124. For these values of dielectric layer thicknesses, a very high reflectance from the Bragg reflector 120 is achieved in the 1200 nm to 1800 nm wavelength range, with the reflectance values≥0.9 in the entire wavelength range, and specifically, the reflectance is about 0.95 at the target wavelength of 1500 nm. Accordingly, most the incident light on the optical element may be reflected by the Bragg reflector 120.

According to various non-limiting embodiments, the spacer 130 may be made of low-index dielectric material including silicon dioxide (SiO₂), calcium fluoride (CaF₂), aluminum oxide (Al₂O₃) and the like. The spacer 130 may have a height enabling Fabry-Perot like resonances. The height of the spacer 130 may be the distance between the nanoparticle 140 and the Bragg reflector 120.

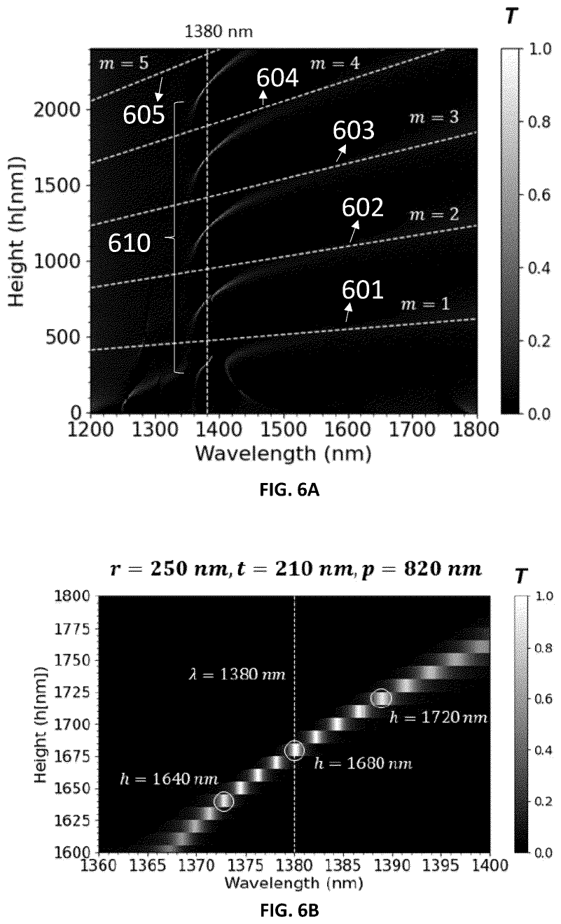

FIG. 6A shows simulated transmission spectra colormap (grayscale) of the optical element 100 with the height of the spacer 130 varying from 0 nm to 2400 nm. The height of the spacer 130 may be designed so as to support Fabry-Perot like resonance. The simulation may be performed by full wave simulation for the optical element 100. Similar to FIG. 4A, the nanoparticle 140 is set to have a radius r=250 nm, and a thickness t=210 nm; and the XY periodicity p is set to 820 nm. FIG. 6A shows bent curves 610 (grey/white in colour) with high transmittance according to the right vertical axis T, the pattern of which repeats itself periodically as the height increases, indicating the emergence of Fabry-Perot cavity like modes in the optical element 100. The periodic pattern of the bent curves 610 as shown in FIG. 6A shows strong bending near the resonance around λ=1380 nm as shown in FIG. 4A.

The Fabry-Perot (FP) resonance condition may be determined using the equation:

$${h}_{dashed} = \frac{m λ}{2 {n}_{c a v i t y}} \qquad ( 2 )$$

where m is an integer representing the order of the Fabry Perot mode (m=1, 2, 3, . . . ), λ is the incident wavelength, n_{cavity} is the refractive index of the material inside the cavity (i.e. the spacer 130), and h_{dashed} is the thickness of the cavity (i.e. the spacer 130). n_{cavity}=n_{SiO2}=1.46. The heights of the spacer 130, h_{dashed}, calculated from equation (2) are plotted in FIG. 6A as slanted white dashed lines 601, 602, 603, 604, 605 for m=1, 2, 3, 4, and 5, respectively. Accordingly, for each order of the Fabry Perot mode (m=1, 2, 3, . . . ), one of the bent curves 610 of high transmittance is obtained as shown in FIG. 6A. The dashed Fabry Perot lines 601, 602, 603, 604, 605 and the bent curves 610 around the resonance may indicate strong coupling between the metasurface resonances and the FP cavity resonance, i.e. the physical mechanism behind the present transmissive filters. It can be observed that in the present transmissive filter system, the resonances with the high transmission can be achieved around the reflection peak (λ=1380 nm), i.e. the band of spectral overlapping of the ED and MD resonances of the bare dielectric metasurface (i.e. the nanoparticle 140), with suppressed transmission for all other wavelengths around it.

FIG. 6B shows an enlarged section of FIG. 6A where m is 3 and the wavelength is around 1380 nm corresponding to the resonance as shown in FIG. 4A. FIG. 6B shows high transmission resonances (T>0.8) can also be obtained in a continuous range of heights of the spacer 130 (i.e. distances the metasurface, i.e. the nanoparticle 140, to the Bragg reflector 120) from h=1630 nm to h=1730 nm.

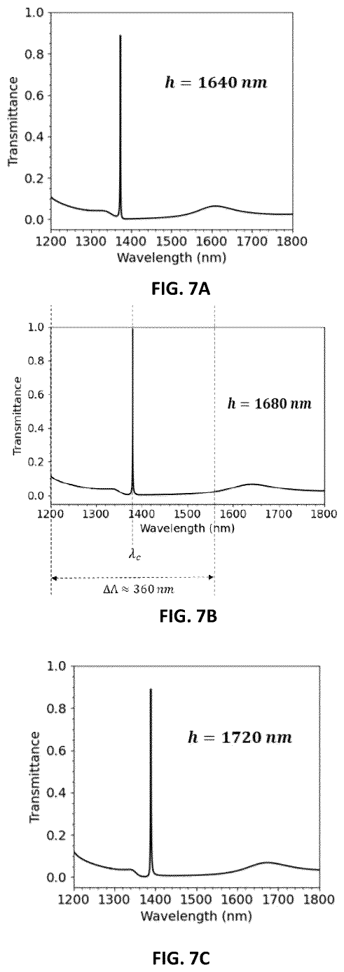

FIGS. 7A to 7C show the transmittance spectra for the particular cases h=1640 nm, 1680 nm, and 1720 nm, respectively, in accordance with the circled points of FIG. 6B. In all cases, the spectra display narrow transmission bands associated with high transmission and, more importantly, a wide rejection bandwidth where transmission is less than 0.1. This demonstrates that the optical element 100 can act as a high-performance transmissive filter in the wavelength region of interest. A full width at half maxima (FWHM) of FIG. 7B is as narrow as 1 nm resulting quality factor (Q-factor) as high as of the order of 10³:

$$Q - factor = {λ}_{r e s} / FWHM \qquad ( 3 )$$

where λᵣₑₛ is the resonance wavelength in transmission.

In FIG. 7B, a rejection bandwidth (ΔΛ) of the filter is defined as the wavelength range across which the transmission is below <0.1, and this is calculated by taking the same wavelength range across the left and right sides of the central wavelength (λ_{c}) or the resonance position of the transmitted light. The rejection bandwidth is as wide as ΔΛ≈360 nm. Similarly, for the transmitted resonances in FIGS. 7A and 7C, the rejection bandwidths are greater than 350 nm.

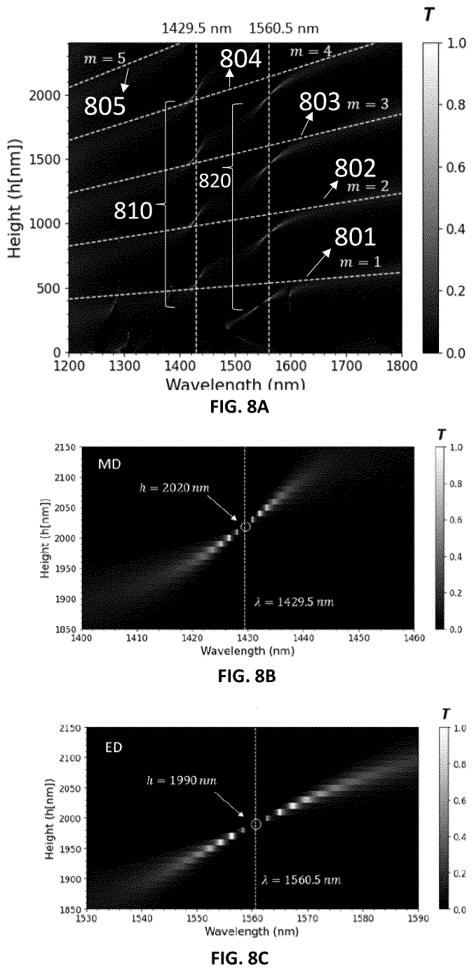

FIG. 8A shows simulated transmission spectra colormap (grayscale) of the optical element 100 with the height of the spacer 130 varying from 0 nm to 2400 nm. The simulation may be performed by full wave simulation for the optical element 100. Similar to FIG. 4B, the nanoparticle 140 is set to have a radius r=320 nm, and a thickness t=210 nm; and the XY periodicity p is set to 820 nm. FIG. 8A shows two sets of bent curves 810, 820 (grey/white in colour) with high transmittance according to the right vertical axis T, the pattern of which repeats itself periodically as the height increases, indicating the emergence of Fabry-Perot cavity like modes in the optical element 100. The periodic pattern of the bent curves 810, 820 as shown in FIG. 8A shows strong bendings near the resonance around λ=1429.50 nm, 1560 nm, respectively, as shown in FIG. 4B.

The heights of the spacer 130, h_{dashed}, calculated from the above equation (2) are plotted in FIG. 8A as slanted white dashed lines 801, 802, 803, 804, 805 for m=1, 2, 3, 4, and 5, respectively. Accordingly, for each order of the Fabry Perot mode (m=1, 2, 3, . . . ), each of the bent curves 810, 820 of high transmittance is obtained as shown in FIG. 8A. The dashed Fabry Perot lines 801, 802, 803, 804, 805 and the bent curves 810, 820 around the two distinct resonances indicates strong coupling between the metasurface resonances and the FP cavity resonance. It can be observed that in the present transmissive filter system, the resonances with the high transmission can be achieved around the two reflection peaks (λ=1429.5 nm, 1560.5 nm), i.e. the bands of the respective ED and MD resonances of the bare dielectric metasurface (i.e. the nanoparticle 140), with suppressed transmission for all other wavelengths around it.

FIGS. 8B and 8C show enlarged sections of FIG. 8A where m is 3 and the wavelength is around 1429.5 nm and 1560.5 nm, respectively, corresponding to the MD and ED resonances as shown in FIG. 4B. In contrast to FIG. 6B; FIG. 8B and FIG. 8C do not show that high transmission resonances (T>0.8) can be obtained in a continuous range of heights of the spacer 130 but that the transmission around the metasurface resonances (the MD resonance and the ED resonance) drops to zero. Particularly, as shown in FIG. 8B, the transmission drops to nearly zero as the height of the spacer 130 increases or decreases from 2020 nm and the wavelength increases or decreases from the MD resonance of 1429.5 nm.

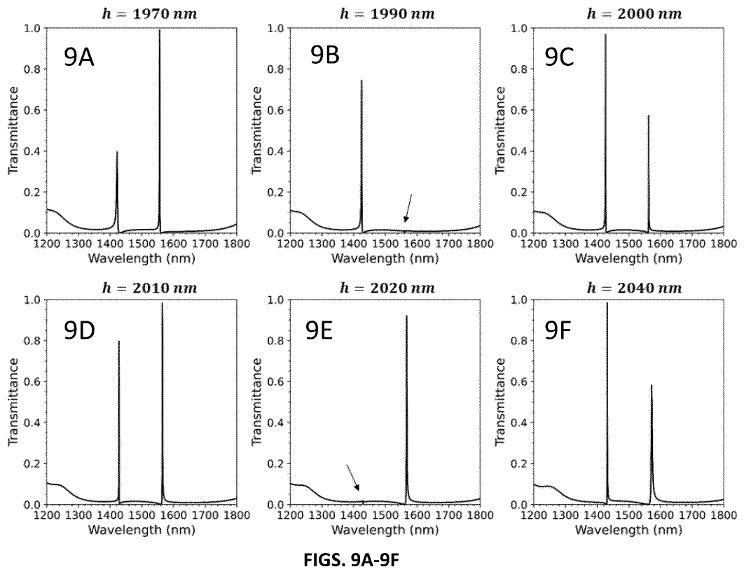

FIGS. 9A to 9F show the transmittance spectra for the different heights of the spacer 130, h=1970 nm, 1990 nm, 2000 nm, 2010 nm, 2020 nm and 2040 nm, respectively. Particularly, FIG. 9B and FIG. 9E, where h=1990 nm, 2020 nm, correspond to the circled points in FIG. 8B and FIG. 8C, respectively. The high transmittance peaks are obtained in the respective heights of the spacer 130 for the respective wavelengths as shown in FIGS. 9A to 9F. Two transmission bands are simultaneously present in FIGS. 9A, 9C, 9D and 9F, one near the MD resonance and another near the ED resonance of the bare metasurface. This may, in turn, restrict the rejection band in these configurations, reducing the performance compared to the cases in which the metasurface supports the two overlapped resonances. While it is still possible to obtain single transmission bands in this configuration, as shown in FIG. 9B and FIG. 9E, even the slightest variation in the height of the spacer 130 (i.e. the distance between the Bragg reflector 120 and the nanoparticle 140) may break this condition, making it prone to performance deterioration with fabrication imperfections. Hence, the radius of the nanoparticle 140 may be desired to be so designed to cause overlapped resonances, for example, in a range of 150 nm to 260 nm, particularly, r=250 nm.

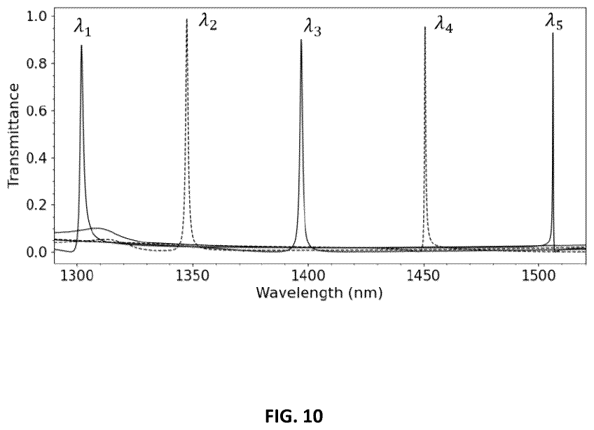

FIG. 10 shows simulated transmission graphs as a function of wavelengths for the optical element 100. The simulation may be performed by full wave simulation for the optical element 100. The height (e.g. t=210 nm) of the nanoparticle 140 and the height (e.g. h=1660 nm) of the spacer 130 are kept unchanged for FIG. 10; and the radius (e.g. r) of the nanoparticle 140 and the XY-periodicity (e.g. p) of the optical element 100 vary. FIG. 10 shows that the positions of the transmitted resonances are tuned in accordance with the wavelengths and the operating wavelengths scan in a range as wide as 200 nm (e.g. from λ₁ to λ₅ as denoted in FIG. 10), while maintaining high transmission T>0.85 of the filtered resonances. Moreover, wide rejection bandwidths (where T<0.1) are obtained for all the operating wavelengths in the range. This feature makes the present transmissive filters useful to realize compact optical spectrometers by, e.g. directly integrating them above pixelated photodetectors, as described herein.

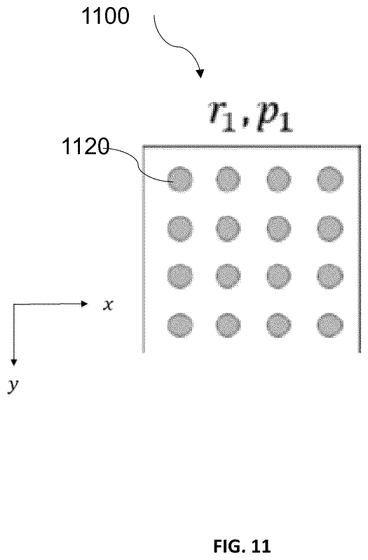

FIG. 11 is a block diagram depicting an optical unit 1100 according to various embodiments of the present disclosure. According to various non-limiting embodiments, the optical unit 1100 may include an array of optical elements.

According to some embodiments, the optical elements may be similar to the optical element 100 of FIG. 1, and thus various embodiments, modifications and variations described with reference to the optical element 100 of FIG. 1 are analogously valid for the optical elements of FIG. 11, and vice versa. Each of the optical elements may include a substrate, a Bragg reflector disposed on the substrate, a nanoparticle 1120 (with a radius of r₁), disposed over the Bragg reflector, and a spacer disposed between the Bragg reflector and the nanoparticle 1120. The nanoparticle 1120 may be surrounded by dielectric material disposed on the spacer. The optical element may have a XY periodicity of p₁, p₁, that is, a same periodicity in the X- and Y-directions (e.g. a square). The optical elements may be periodically arranged in the X- and Y-directions, the X- and Y-directions being perpendicular to a transmission direction (i.e. the Z-direction) of the optical elements, and the nanoparticles 1120 of the array of the optical elements may form a metasurface configured to resonate with incident light on the optical unit 1100.

According to other embodiments, the optical unit 1100 may include a substrate; a Bragg reflector disposed on the substrate; a spacer disposed on the Bragg reflector; a metasurface disposed on the spacer and configured to resonate with incident light on the optical unit, the metasurface comprising an array of nanoparticles 1120 surrounded by dielectric material. The nanoparticles 1120 may be similar to the nanoparticle 140 of FIG. 1, and thus various embodiments, modifications and variations described with reference to the nanoparticle 140 of FIG. 1 are analogously valid for the nanoparticles 1120 of FIG. 11, and vice versa.

According to various non-limiting embodiments, the nanoparticles 1120 of the array of the optical elements may be of a same height and radius (i.e. r₁).

According to various non-limiting embodiments, the metasurface may be symmetrical in the X-Y plane.

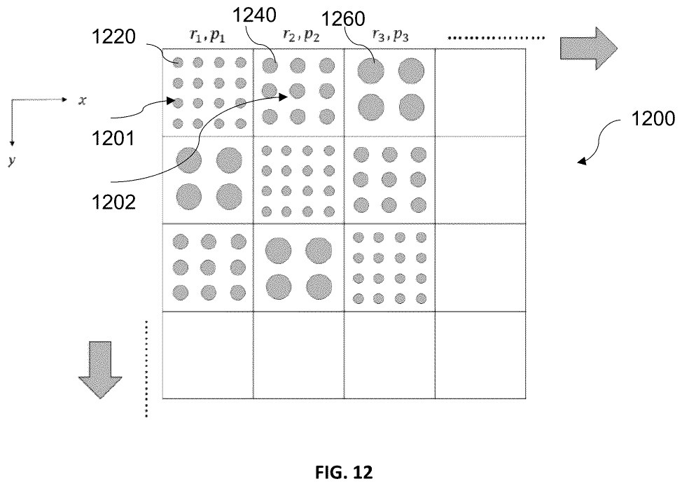

FIG. 12 is a block diagram depicting an optical device 1200 according to various embodiments of the present disclosure. According to some embodiments, the optical device 1200 may include an array of optical units. The optical units may be similar to the optical unit 1100 of FIG. 11, and thus various embodiments, modifications and variations described with reference to the optical unit 1100 of FIG. 11 are analogously valid for the optical units of FIG. 12, and vice versa.

According to various non-limiting embodiments, nanoparticles 1220, 1240, 1260, of the array of the optical units may be of the same height and the nanoparticles of the array of the optical units forms a metasurface configured to resonate with incident light on the optical device 1200. The nanoparticles 1220, 1240, 1260 may be similar to the nanoparticle 140 of FIG. 1 and the nanoparticles 1120 of FIG. 11, and thus various embodiments, modifications and variations described with reference to the nanoparticle 140 of FIG. 1 and the nanoparticles 1120 of FIG. 11 are analogously valid for the nanoparticle 1220, 1240, 1260 of FIG. 12, and vice versa.

According to various non-limiting embodiments, radii of nanoparticles 1220, 1240, 1260 in one unit (e.g. r₁ in the optical unit 1201) of the array of the optical units may be different from radii of nanoparticles 1220, 1240, 1260 in a neighboring unit (e.g. r₂ in the optical unit 1202) of the array of the optical units.

According to various non-limiting embodiments, the array of the optical units may be of a same length and width in the X- and Y-directions, respectively.

According to various non-limiting embodiments, the optical device may include a transmissive planar filter, in particular, a pixelated transmissive filter. Each pixel (i.e. each optical unit) of the pixelated transmissive filter may be designed so as to have a different operation wavelength (transmission band) by having a different geometrical parameter (e.g. radius r, or lattice period) of the nanoparticles. In other words, each pixel may include a dielectric metasurface with different cross-sectional geometry of the nanoparticles.

According to other embodiments, the optical device 1200 may include a substrate; a Bragg reflector disposed on the substrate; a spacer disposed on the Bragg reflector; a metasurface disposed on the spacer and configured to resonate with incident light on the optical device, the metasurface comprising a plurality of arrays of nanoparticles 1220, 1240, 1260 surrounded by dielectric material. One array (e.g. 1220) of nanoparticles 1220, 1240, 1260 may have a radius different from a radius of a neighboring array (e.g. 1240) of nanoparticles 1220, 1240, 1260.

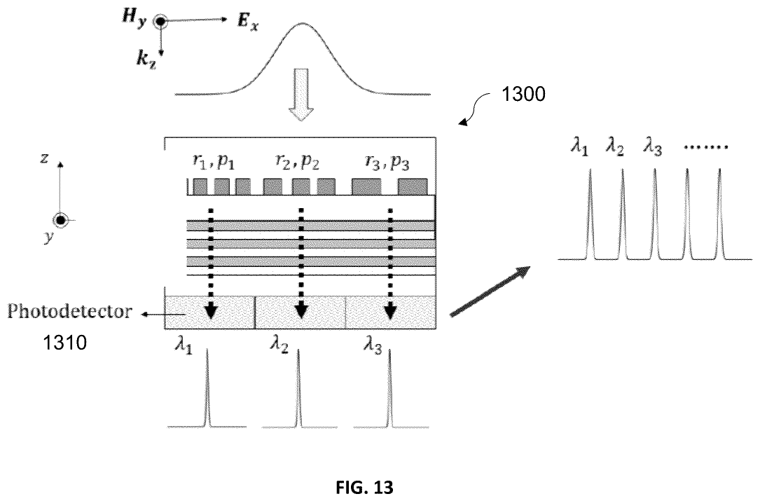

According to various non-limiting embodiments, as shown in FIG. 12, the pixelated structure, with each optic unit 1201, 1202 representing the area of a single pixel (or an array of pixels) designed to filter a particular wavelength of interest. In some embodiments, this may be achieved by using arrays of cylindrical nanoparticles 140 with different radius, rₙ and/or period, pₙ with the aim of targeting wavelength λₙ in each pixel in the transmission (here subscript n=1, 2, 3 . . . ), while maintaining the same thickness, t of the metasurface and the same height of the spacer, h, as shown in the cross-sectional view in FIG. 13. Each pixelated area with the metasurface may target either the same or different wavelengths in transmission depending on their geometrical parameters (rₙ, pₙ).

FIG. 13 is a block diagram depicting an optical device 1300 according to various embodiments of the present disclosure. The optical device 1300 may include the optical device 1200 of FIG. 12, and thus various embodiments, modifications and variations described with reference to the optical device 1200 of FIG. 12 are analogously valid for the optical device 1300 of FIG. 13, and vice versa. The optical device 1300 may further include an array of photodetectors 1310 (or a pixelated photodetector) for detecting transmitted signals.

According to various non-limiting embodiments, the spacer(s) of the optical device 1300 may have a same height h, and the radii of the nanoparticles of the optical device may have a same thickness t, the optical device 1300 (e.g. a pixelated filter) may be advantageously fabricated through standard lithography and deposition techniques. Due to the planar construction of the optical device 1300, it may then be directly integrated on top of a photodetector (CMOS, CCD, APD etc.) pixel, thereby advantageously miniaturizing the overall device without the need of other bulky optics components.

According to various non-limiting embodiments, a broadband light may be incident from the top. The light then passes through the pixelated optical device 1300 with the metasurface having the nanoparticles of different radius (r) and period (p) and fixed thickness (t), and the spacer(s) of fixed height (h) above the Bragg reflector. Depending on the radius and periodicity of the metasurface, a particular wavelength (λₙ, n=1, 2, 3, . . . ) is transmitted. This intensity of the transmitted light may be then directly recorded on the photodetector pixels 1310. A wide range of wavelengths may be scanned using the present optical device and thus the spectrum of the incident broadband light may be reconstructed.

The present optical device may include a planar transmissive filter including a dielectric metasurface, a Bragg reflector, and a spacer between them. The present planar transmissive filter may form an optical cavity where two spectrally overlapped Mie resonances excited in the metasurface interact with the Bragg reflector forming a cavity resonance to give high transmission resonance with very high Q-factors and wide rejection bandwidth. In some embodiments, the present planar transmissive filter may work in the infrared regime and be scaled to other wavelength regions. The present planar transmissive filter may be easily integrated over the photodetector pixel arrays, playing a significant role in the miniaturization and realization of simple and compact spectrometers. The present planar transmissive filter may have applications in the fields of sensing, imaging, analysis and detection, to name a few.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of implementations have been described. Nevertheless, it will be understood that various modifications can be made. Accordingly, other implementations are within the scope of the following claims.

1. An optical element, comprising:
a substrate;
a Bragg reflector disposed on the substrate;
a nanoparticle disposed over the Bragg reflector; and
a spacer disposed between the Bragg reflector and the nanoparticle,
wherein the nanoparticle is surrounded by dielectric material disposed on the spacer.

2. The optical element of claim 1, wherein the Bragg reflector comprises a distributed Bragg reflector having a multilayer stack of alternate high- and low-index optically thin films.

3. The optical element of claim 2, wherein thicknesses of the high- and low-index optically thin films are in proportion to a target wavelength and inversely proportional to refractive indexes of the high- and low-index optically thin films, and the thicknesses of the high-index optically thin films are less than the thicknesses of the low-index optically thin films.

4. The optical element of claim 2, wherein the high-index optically thin films are made of silicon (Si), titanium dioxide (TiO₂), silicon nitride (Si₃N₄), gallium nitride (GaN), and/or gallium phosphide (GaP), and the low-index optically thin films are made of silicon dioxide (SiO₂), calcium fluoride (CaF₂), and/or aluminium oxide (Al₂O₃).

5. The optical element of claim 1, wherein the spacer is made of low-index dielectric material including at least one of silicon dioxide (SiO₂), calcium fluoride (CaF₂), or aluminium oxide (Al₂O₃).

6. The optical element of claim 1, wherein the nanoparticle is made of high refractive index dielectric and semiconductor materials including at least one of amorphous silicon (α-Si), titanium dioxide (TiO₂), silicon nitride (Si₃N₄), gallium nitride (GaN), gallium phosphide (GaP), or diamond.

7. The optical element of claim 1, wherein the substrate is made of low-index dielectric material including at least one of silicon dioxide (SiO₂), calcium fluoride (CaF₂), or aluminium oxide (Al₂O₃).

8. The optical element of claim 1, wherein the nanoparticle is surrounded by low-index dielectric material including at least one of silicon dioxide (SiO₂), calcium fluoride (CaF₂), or aluminium oxide (Al₂O₃).

9. The optical element of claim 1, wherein the spacer has a height enabling Fabry-Perot like resonances.

10. The optical element of claim 1, wherein the nanoparticle is of a cylindrical shape, a cubical shape, a cuboid shape, or a cross shape.

11. The optical element of claim 1, wherein the nanoparticle has a radius enabling overlapped electric pole and magnetic pole resonances.

12. An optical unit, the optical unit comprising:
an array of optical elements, wherein each optical element is configured as recited in claim 1,
wherein the optical elements are periodically arranged in the X- and Y-directions, the X- and Y-directions being perpendicular to a transmission direction of the optical elements, and nanoparticles of the array of optical elements form a metasurface configured to resonate with incident light on the optical unit; or
the optical unit comprising:
a substrate;
a Bragg reflector disposed on the substrate;
a spacer disposed on the Bragg reflector;
a metasurface disposed on the spacer and configured to resonate with incident light on the optical unit, the metasurface comprising an array of nanoparticles surrounded by dielectric material.

13. The optical unit of claim 12, wherein the nanoparticles of the array of optical elements are of a same height and radius.

14. The optical unit of claim 12, wherein the metasurface is symmetrical in its plane.

15. An optical device, comprising:
an array of optical units, wherein each optical unit is configured as recited in claim 12,
wherein nanoparticles of the array of optical units are of the same height.

16. The optical device of claim 15, wherein radii of nanoparticles in one optical unit of the array of optical units are different from radii of nanoparticles in a neighbouring unit of the array of optical units.

17. The optical device of claim 15, wherein the array of optical units is of a same length and width, respectively.

18. The optical device of claim 15, wherein the optical device comprises a transmissive planar filter.

19. An optical device, comprising:
a substrate;
a Bragg reflector disposed on the substrate;
a spacer disposed on the Bragg reflector;
a metasurface disposed on the spacer and configured to resonate with incident light on the optical device, the metasurface comprising a plurality of arrays of nanoparticles surrounded by dielectric material.

20. The optical device of claim 19, wherein one array of nanoparticles has a same radius different from a same radius of a neighbouring array of nanoparticles.
